(19) United States
(12) Patent Application Publication
(10) Pub. No.: US 2011/0209182 A1
(43) Pub. Date: Aug. 25, 2011

(54) APPARATUS AND METHOD FOR TRANSMITTING MULTIMEDIA CONTENTS, AND SYSTEM AND METHOD FOR RELAYING MULTIMEDIA CONTENTS

(76) Inventors: Sang-Ju Wang, Seoul (KR); Adrianne Jeewon Wang, Seoul (KR); Jee-Hyun Wang, Seoul (KR)

(21) Appl. No.: 13/060,575

(22) PCT Filed: Aug. 26, 2009
(86) PCT No.: PCT/KR2009/004770

§ 371 Date: May 16, 2011

(30) Foreign Application Priority Data
Aug. 27, 2008 (KR) 10-2008-0083957

(51) Int. Cl. H04N 7/16

(52) U.S. Cl. 725/62

(57) ABSTRACT

Provided are an apparatus and method for transmitting multimedia contents and a system and method for relaying multimedia contents, and more particularly, an apparatus for transmitting multimedia contents, the apparatus generating an image using a camera therein when receiving a call channel request signal from a requesting terminal and transmitting the generated image to the requesting terminal, a method of transmitting multimedia contents, and a system and method for relaying multimedia contents. The apparatus for transmitting multimedia contents includes: an identification unit identifying whether a received signal is a signal for requesting a call channel; and a communication unit transmitting an image of a subject captured by a camera over a mobile

### TECHNICAL FIELD

The present invention relates to an apparatus and method for transmitting multimedia contents and a system and method for relaying multimedia contents, and more particularly, to an apparatus for transmitting multimedia contents, the apparatus generating an image using a camera therein when receiving a call channel request signal from a requesting terminal and transmitting the generated image to the requesting terminal, a method of transmitting multimedia contents, and a system and method for relaying multimedia contents.

### BACKGROUND ART

Closed-circuit television (CCTV) is a television system that transmits images to specific receivers. Images are transmitted and received in a wired or wireless manner, and CCTV is called as such because it transmits images only to specific receivers.

CCTV, also called “industrial television (ITV),” has various applications in broadcast television, industry, education, medicine, disaster prevention, visual information exchange within a company, and the like. In particular, visual information transmitted from CCTV contains a far greater amount of information than data or audio information transmitted from other media. Thus, even the atmosphere and feelings of people at the site can be conveyed to viewers.

A camera used in a CCTV system is generally called a “closed-circuit camera.” A closed-circuit camera converts an image input to a lens therein into an electrical signal by using an image pickup device such as a charge coupled device (CCD) or a complementary metal-oxide semiconductor (CMOS) and transmits the electrical signal to a display device (such as a monitor) by using a cable.

### DISCLOSURE OF INVENTION

### Technical Problem

CCTV system using a closed-circuit camera can be utilized for crime prevention, surveillance, and the like. As described above, an electrical signal of an image generated by a closed-circuit camera is transmitted to a display device (such as a monitor) through a cable. Thus, the closed-circuit camera must be connected to the monitor in a wired manner. That is, the implementation of a CCTV system is constrained by space limitations.

To wirelessly transmit or receive visual information, each of the closed-circuit camera and the monitor may include a wireless transceiver. In this case, however, the transmission/reception range of the wireless transceiver serves as a limiting factor, and the cost of implementing a wireless system is additionally incurred.

Therefore, it is required to develop an invention which can receive an image of the situation in a remote area using a conventional system.

It is an objective of the present invention to generate an image using a camera when receiving a call channel request signal from a requesting terminal and transmit the generated image to the requesting terminal.

### Solution to Problem

According to an aspect of the present invention, there is provided an apparatus for transmitting multimedia contents. The apparatus includes: an identification unit identifying whether a received signal is a signal for requesting a call channel; and a communication unit transmitting an image of a subject captured by a camera over a mobile communication network, based on the identification result.

According to another aspect of the present invention, there is also provided a system for relaying multimedia contents. The system includes: an identification apparatus receiving a signal for requesting a call channel and identifying whether a first terminal requested to provide the call channel is transmitting an image; and a communication apparatus transmitting the image to a second terminal, which requested the call channel, based on the identification result.

According to another aspect of the present invention, there is also provided a method of transmitting multimedia contents. The method includes: identifying whether a received signal is a signal for requesting a call channel; and transmitting an image of a subject captured by a camera over a mobile communication network, based on the identification result.

According to another aspect of the present invention, there is also provided a method of relaying multimedia contents. The method includes: receiving a signal for requesting a call channel and identifying whether a first terminal requested to provide the call channel is transmitting an image; and transmitting the image to a second terminal, which requested the call channel, based on the identification result.

However, aspects of the present invention are not restricted to the one set forth herein. The above and other aspects of the present invention will become more apparent to one of ordinary skill in the art to which the present invention pertains by referencing the detailed description of the present invention given below.

### BRIEF DESCRIPTION OF DRAWINGS

FIG. 1 is a conceptual diagram illustrating a process of transmitting an image in response to a call channel request, according to an exemplary embodiment of the present invention;

FIG. 2 is a diagram illustrating a mobile communication system according to an exemplary embodiment of the present invention;

FIG. 3 is a block diagram of an apparatus for transmitting multimedia contents according to an exemplary embodiment of the present invention;

FIG. 4 is a diagram illustrating a terminal relay system according to an exemplary embodiment of the present invention;

FIG. 5 is a diagram illustrating a control option table according to an exemplary embodiment of the present invention;

FIG. 6 is a flowchart illustrating a method of transmitting multimedia contents according to an exemplary embodiment of the present invention;

FIG. 7 is a flowchart illustrating a method of transmitting multimedia contents according to another exemplary embodiment of the present invention; and

FIG. 8 is a flowchart illustrating a method of relaying multimedia contents according to an exemplary embodiment of the present invention.

### MODE FOR THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete, and will fully convey the concept of the invention to those skilled in the art.

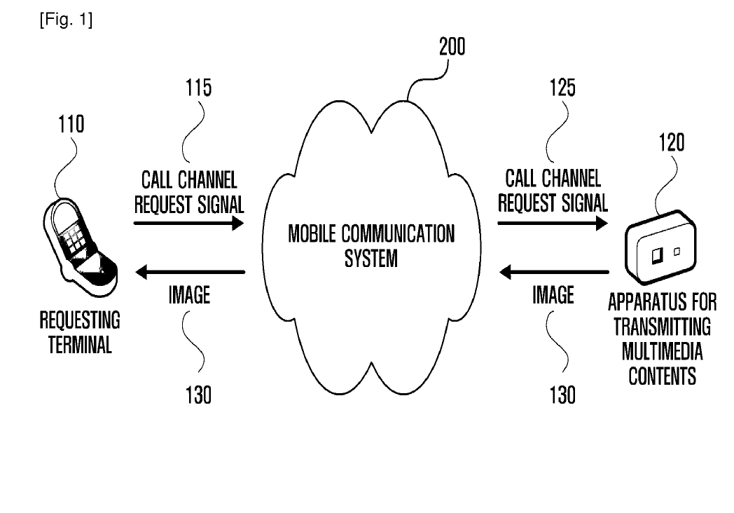

FIG. 1 is a conceptual diagram illustrating a process of transmitting an image in response to a call channel request, according to an exemplary embodiment of the present invention.

Referring to FIG. 1, when desiring to identify the situation in a remote area, a user transmits a call channel request signal 115 to an apparatus 120 for transmitting multimedia contents, which includes a camera, by using his or her terminal (i.e., a requesting terminal 110). For example, the user may enter numbers of the apparatus 120 into his or her terminal and press the ‘Call’ button.

The call channel request signal 115 transmitted from the requesting terminal 110 is delivered to a mobile communication system 200. Then, the mobile communication system 200 relays the call channel request signal 115 to the apparatus 120. Here, the call channel request signal 115 between the requesting terminal 110 and the mobile communication system 200 may be identical to or different from a call channel request signal 125 between the mobile communication system 200 and the apparatus 120. The call channel request signal 115 includes an outgoing call transmitted from the requesting terminal 110, whereas the call channel request signal 125 includes an incoming call for making a call request to the apparatus 120.

The apparatus 120, which receives the call channel request signal 125, identifies whether the received signal 125 is a call channel request signal. When the received signal 125 is a call channel request signal, the apparatus 120 operates its camera and generates an image 130 of a subject captured by the camera.

Then, the apparatus 120 transmits the generated image 130 to the mobile communication system 200. Accordingly, the mobile communication system 200 relays the received image 130 to the requesting terminal 110. That is, even without user inputs, the apparatus 120 can operate its camera and transmit the image 130, based on a received signal.

Therefore, the requesting terminal 110 can receive the image 130 from the apparatus 120 by simply sending a call channel request to the apparatus 120. That is, the apparatus 120 operates its camera and transmits the image 130 in response not to a signal for requesting the image 130, but to the call channel request signal 125.

The apparatus 120 for transmitting multimedia contents according to the current exemplary embodiment performs the function of transmitting the image 130 of a subject captured by its camera to the requesting terminal 110. Accordingly, the apparatus 120 may include the camera and a mobile communication unit. The apparatus 120 may further include an identification unit which identifies whether a received signal is a call channel request signal.

In FIG. 1, one requesting terminal 110 and one apparatus 120 for transmitting multimedia contents are illustrated. However, image transmission may also be performed between a plurality of devices. For example, one requesting terminal 110 may receive the image 130 from a plurality of apparatuses for transmitting multimedia contents, or a plurality of requesting terminals may receive the image 130 from one apparatus 120 for transmitting multimedia contents. Alternatively, a plurality of requesting terminals may receive the image 130 from a plurality of apparatuses for transmitting multimedia contents.

Such image transmission between a plurality of devices may be managed by the mobile communication system 200.

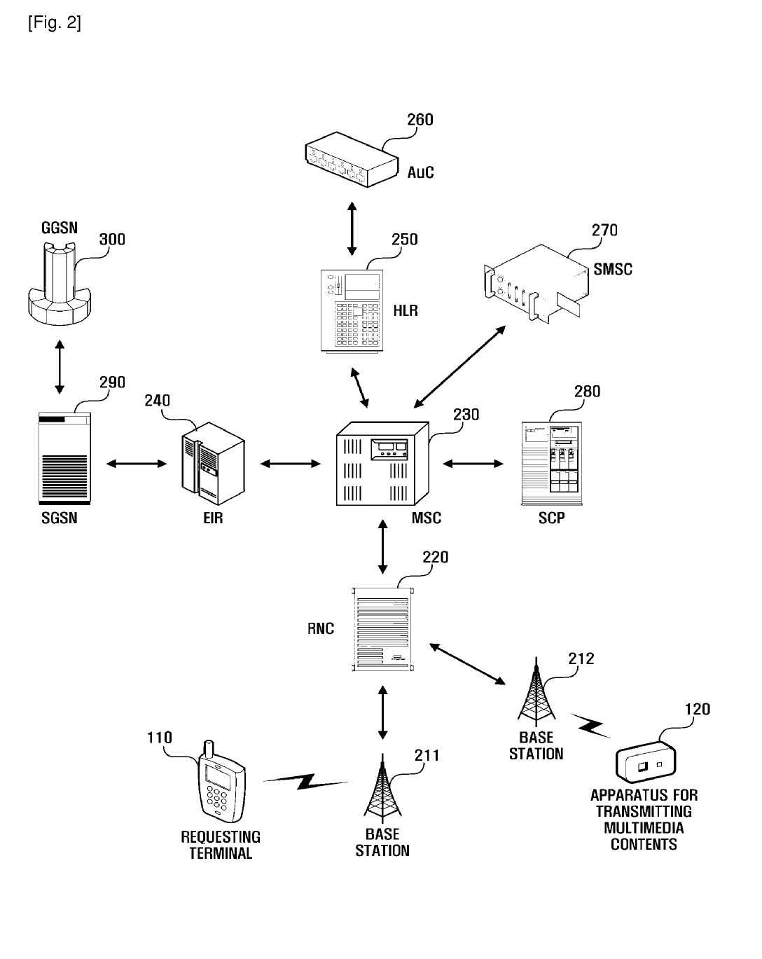

FIG. 2 is a diagram illustrating a mobile communication system 200 according to an exemplary embodiment of the present invention.

A mobile communication network of the mobile communication system 200 according to the current exemplary embodiment may be, but not limited to, based on code division multiple access (CDMA), wideband CDMA (WCDMA), or global system for mobile telecommunication (GSM).

Referring to FIG. 2, the mobile communication system 200 includes base stations 211 and 212, a radio network controller (RNC) 220, a mobile switching center (MSC) 230, an equipment identity register (EIR) 240, a home location register (HLR) 250, an authentication center (AuC) 260, a short message service center (SMSC) 270, a service control point (SCP) 280, a serving general packet radio service (GPRS) support node (SGSN) 290, and a gateway GPRS support node (GGSN) 300.

A requesting terminal 110 may be a mobile communication device such as a mobile phone or a personal digital assistant (PDA). The requesting terminal 110 may have a terminal identifier. The terminal identifier is a unique value that distinguishes the requesting terminal 110 from other terminals. Whenever a requesting terminal is produced, a terminal identifier is allocated to the requesting terminal by a terminal manufacturer or an authorized entity.

An information card having a subscriber identifier may be connected to the requesting terminal 110. A subscriber identifier is unique information used to identify a subscriber. An example of the subscriber identifier is an international mobile subscriber identity (IMSI). The information card may generate an authentication value using a predetermined authentication function, and the authentication value may be used to authenticate a subscriber in the mobile communication network.

The information card may be connected to the requesting terminal 110 such that it can be inserted into or removed from the requesting terminal 110. Alternatively, the information card may be fixed to the requesting terminal 110 such that it cannot be arbitrarily separated from the requesting terminal 110 by a subscriber. The information card may include a memory which can store data and a central processing unit (CPU) which can carry out an operation. Examples of the information card include a subscriber identity module (SIM) card and a universal subscriber identity module (USIM) card.

As described above, an apparatus 120 for transmitting multimedia contents according to the current exemplary embodiment may include an image pickup unit (such as a camera) and a mobile communication unit. Accordingly, the apparatus 120, like the requesting terminal 110, may have a terminal identifier, and the information card having the subscriber identifier may be connected to the apparatus 120.

In FIG. 2, each component of the mobile communication system 200 is illustrated as one device. However, FIG. 2 is merely a schematic diagram illustrating the basic configuration of the mobile communication system 200, and the present invention is not limited to this configuration. Therefore, each component of the mobile communication system 200 may also be implemented as a plurality of devices, and some of the components of the mobile communication system 200 may be removed. Alternatively, two or more components of the mobile communication system 200 may be combined into one component, and a function performed by one component may be split into a plurality of functions and distributed to and thus performed by a plurality of components.

The base stations 211 and 212 are primary access points of the requesting terminal 110 or the apparatus 120 for transmitting multimedia contents (hereinafter, also referred to as a “terminal”). The base stations 211 and 212 may exchange various signals and data with the terminals 110 and 120. That is, each of the base stations 211 and 212 may function as a wireless modem which includes an antenna and a transmitting/receiving modem. A communication channel in the direction from the terminals 110 and 120 to the base stations 211 and 212 is called an “uplink channel,” and a communication channel in the direction from the base stations 211 and 212 to the terminals 110 and 120 is called a “downlink channel.”

The RNC 220 controls the base stations 211 and 212 and manages radio resources. Specifically, the RNC 220 instructs the base stations 211 and 212 to allocate communication channels to the terminals 110 and 120 and controls the transmit power of the base stations 211 and 212. In addition, the RNC 220 may support handovers of the terminals 110 and 120 which move between the base stations 211 and 212.

The MSC 230 is connected to one or more RNCs 220 and relays communication between the requesting terminal 110 and the apparatus 120 for transmitting multimedia contents. According to an exemplary embodiment, the MSC 230 may also perform the function of authenticating users of the terminals 110 and 120.

The EIR 240 manages terminal identifiers of terminals produced by terminal manufacturers. An example of a terminal identifier is an IMEI. A terminal identifier of a newly manufactured terminal may be obtained directly from a manufacturer of the terminal or from a server (not shown) which processes the registration of new terminals manufactured by terminal manufacturers.

The EIR 240 may also manage state information of the terminals 110 and 120. The state information of each of the terminals 110 and 120 may include information indicating whether each of the terminals 110 and 120 is normal. According to an exemplary embodiment, the state information of each of the terminals 110 and 120 may be set to any one of ‘white’ (indicating normal), ‘black’ (indicating abnormal), and ‘gray’ (indicating presumably abnormal).

When any one of the terminals 110 and 120 is registered as a stolen terminal or may cause the mobile communication network to malfunction, its state information may be set to ‘black.’ In addition, when a terminal fails to satisfy communication conditions required by the mobile communication network or when it is not clear whether the terminal is normal or abnormal, the state information of the terminal may be set to ‘gray.’ The present invention is not limited by an embodiment of a method used by the EIR 240 to collect the state information of the terminals 110 and 120. Thus, a detailed description of the method will be omitted.

When the state information of any one of the terminals 110 and 120 is ‘black,’ the communication of the terminal 110 or 120 may be blocked in the mobile communication network. However, when the state information of any one of the terminals 110 and 120 is ‘gray,’ the communication of the terminal 110 or 120 may or may not be blocked, depending on embodiments.

The EIR 240 may store mapping information created by mapping the state information of each of the terminals 110 and 120 to a terminal identifier of the terminal 110 or 120. For example, when the EIR 240 obtains a terminal identifier of a new terminal, it may map ‘white’ (i.e., the state information of the new terminal) to the terminal identifier of the new terminal. If any one of the terminals 110 and 120 is registered as a lost terminal, the EIR 240 may change the state information of the terminal 110 or 120, which is mapped to the terminal identifier thereof, from ‘white’ to ‘black.’

The SCP 280 manages an intelligent network service that is to be provided to the terminals 110 and 120. For example, the SCP 280 may manage a short message service (SMS) or an unstructured supplementary services data (USSD)-based message transmission service for the terminals 110 and 120.

The SCP 280 may operate a service logic appropriate for each of the terminals 110 and 120 based on attribute information of each of the terminals 110 and 120. The SCP 280 may manage attribute information of various terminals manufactured by terminal manufacturers. In an exemplary embodiment, there may exist a separate server (not shown) which manages the attribute information of each of the terminals 110 and 120, and the SCP 280 may access the server and identify the attribute information of each of the terminals 110 and 120. Here, the attribute information may include information about functions or performance of each of the terminals 110 and 120, such as languages that can be supported by each of the terminals 110 and 120, screen resolution of each of the terminals 110 and 120, and the type of codec included in each of the terminals 110 and 120.

The HLR 250 manages location information of each subscriber (e.g., a visitor location register (VLR) address, an MSC address, or the like of a place where each of the terminals 110 and 120 is located now) and additional subscriber service information.

The AuC 260 supports the function of authenticating a subscriber to the mobile communication and the function of encrypting a wireless call section. In FIG. 2, the AuC 260 is independent from the HLR 250. However, the AuC 260 may also be included in the HLR 250.

The SGSN 290 processes packet data. That is, the SGSN 290 provides a switching service for packet data.

The GGSN 300 functions as an interface between a GPRS backbone network and an external packet data network. That is, the GGSN 300 is an entity of the GPRS network which functions as a radio gateway between the SGSN 290 and a packet data network (PDN), and each of the terminals 110 and 120 accesses the PDN through the GGSN 300.

To this end, the GGSN 300 converts a GPRS packet received from the SGSN 290 into an appropriate packet data protocol (PDP) format and converts a PDP address of incoming packet data into an address of a destination terminal.

The GGSN 300 may also store an address of the SGSN 290 of a terminal, which is included in a location register of the SGSN 290, and user profiles and perform authentication and billing functions.

To receive an image from the apparatus 120 for transmitting multimedia contents, a user of the requesting terminal 110 transmits a call channel request signal to the apparatus 120.

Accordingly, the MSC 230 receives the call channel request signal, identifies the location of the apparatus 120 with reference to the HLR 250, and transmits the call channel request signal to the apparatus 120.

The apparatus 120 receives the call channel request signal, that is, an incoming call resulting from a call channel request, generates an image by operating its camera, and transmits the generated image to the requesting terminal 110. Since the image transmitted from the apparatus 120 to the requesting terminal 110 is multimedia contents, it may be delivered to the requesting terminal 110 via the SGSN 290 and the GGSN 300.

The MSC 230 according to the current exemplary embodiment may also verify the identity of the requesting terminal 110 that requested image transmission. That is, the MSC 230 transmits a call channel request signal received only from a terminal, whose identity has been verified to the apparatus 120 for transmitting multimedia contents. To this end, the MSC 230 may store information that can be used to verify the identity of each terminal, such as terminal identifiers or phone numbers. Then, when receiving a request for image transmission from a terminal, the MSC 230 may verify the identity of the terminal based on the stored information.

In the current exemplary embodiment, a case where the MSC 230 verifies the identity of the requesting terminal 110 has been described as an example. However, this is merely an example for a better understanding of the present invention, and the present invention is not limited to the example. That is, the requesting terminal 110 or the apparatus 120 for transmitting multimedia contents may also perform an identity verification process.

For example, a subscriber may input a password (such as numbers or text) to the requesting terminal 110 in advance in order to prevent unauthorized use of the requesting terminal 110, and the input password may be stored in the requesting terminal 110. Thus, the requesting terminal 110 may request the subscriber to enter the password that the subscriber previously input to the requesting terminal 110 before transmitting the call channel request signal. If the password that the subscriber entered is valid, the requesting terminal 110 may transmit the call channel request signal 115 to the mobile communication system 200. Even when the requesting terminal 110 transmits the call channel request signal 115 after the subscriber enters the password, the MSC 230 may also verify the identity of the requesting terminal 110. Alternatively, the MSC 230 may not verify the identity of the requesting terminal 110.

In another example, the apparatus 120 for transmitting multimedia contents may verify the identity of the requesting terminal 110. In this case, the apparatus 120 may store an identifier, phone number, or the like of the requesting terminal 110 in advance. Therefore, even when the requesting terminal 110 or the MSC 230 does not perform the identity verification process, the apparatus 120 can verify the identity of the requesting terminal 110 based on the stored identifier, phone number or the like of the requesting terminal 110 and determine whether to transmit an image based on the verification result.

The identity verification process described above may be performed by any one of or two or more of the MSC 230, the requesting terminal 110, and the apparatus 120.

As described above, image transmission may be performed between a plurality of requesting terminals and the apparatus 120 for transmitting multimedia contents. In this case, the MSC 230 may transmit call channel request signals received from a plurality of requesting terminals to the apparatus 120, so that the requesting terminals can receive an image from the apparatus 120.

Accordingly, a plurality of data communication channels may be formed between the requesting terminals and the apparatus 120. To form a plurality of data communication channels, the apparatus 120 may include a plurality of communication modules.

The MSC 230 may enable an image generated by the apparatus 120 to be transmitted to a plurality of requesting terminals without transmitting call channel request signals from the requesting terminals to the apparatus 120. For example, while one or more requesting terminals are receiving an image from the apparatus 120, if a new requesting terminal transmits a call channel request signal to the MSC 230, the MSC 230 may transmit information about the new requesting terminal to the SGSN 290, so that the SGSN 290 transmits the image generated by the apparatus 120 to the new requesting terminal.

That is, an apparatus (e.g., the GGSN 300) which receives and relays an image from the apparatus 120 for transmitting multimedia contents may generate a plurality of copies of the received image and transmit the generated images to a plurality of requesting terminals.

The number of requesting terminals that can receive an image from the apparatus 120 may be set by an administrator. In this case, if the number of requesting terminals that are currently receiving an image from the apparatus 120 exceeds a preset number, the MSC 230 may transmit a comment or message to a terminal requesting image transmission so as to inform the terminal that the image transmission cannot be performed.

A case where the MSC 230, the SGSN 290 and the GGSN 300 are used to relay an image generated by the apparatus 120 to a plurality of requesting terminals has been described above. However, the case is merely an embodiment.

That is, according to an exemplary embodiment, a system for relaying data (multimedia contents) between the requesting terminal 110 and the apparatus 120 includes an identification apparatus (not shown) and a communication apparatus (not shown). When receiving a call channel request signal from the request terminal 110, the identification apparatus identifies whether the apparatus 120 is now transmitting an image to another terminal. When it is identified that the apparatus 120 is now transmitting an image to another terminal, the communication apparatus (not shown) transmits the image to the requesting terminal 110. Functions of the identification apparatus and the communication apparatus may be performed by at least one of the SGSN 290 and the GGSN 300 or by a separate apparatus.

Here, the separate apparatus may relay data in cooperation with the MSC 230, the SGSN 290, or the GGSN 300.

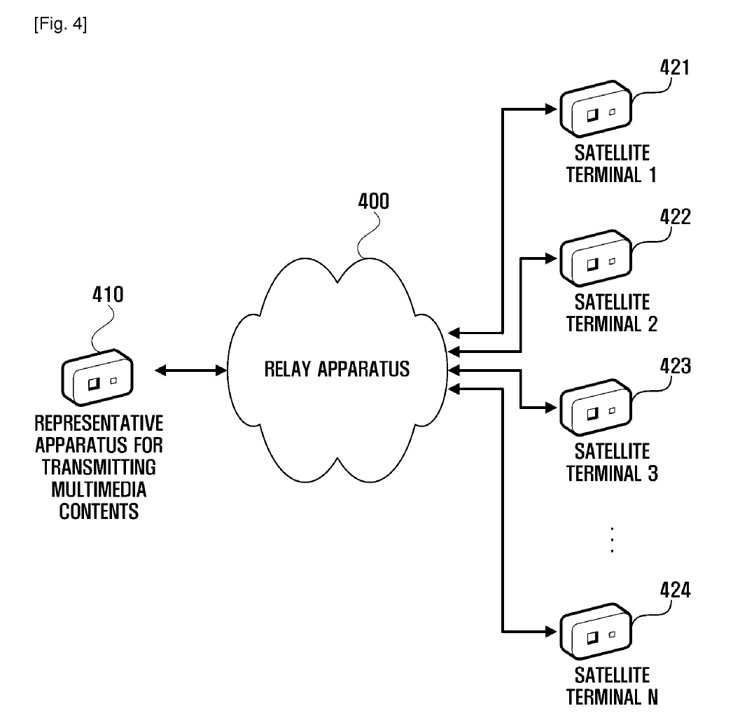

The requesting terminal 110 according to the current exemplary embodiment may also receive images from a plurality of apparatuses for transmitting multimedia contents. In this case, the apparatuses may include a representative apparatus 410 for transmitting multimedia contents which actually communicates with the requesting terminal 110 and one or more satellite terminals 421 through 424 which are connected to the representative apparatus 410 by a relay system, as illustrated in FIG. 4.

Accordingly, while the requesting terminal 110 actually exchanges data only with the representative apparatus 410, it can receive images from the terminals 421 through 424, which will be described in more detail later with reference to FIG. 4.

The SMSC 270 transmits characters, still images, or moving images to the requesting terminal 110. The apparatus 120 according to the current exemplary embodiment may store still images or moving images at any time or at a preset time and transmit the stored multimedia contents to the requesting terminal 110 in response to an image transmission request from the requesting terminal 110.

A case where the mobile communication system 200 relays packet data using the GGSN 300 has been described above. However, the mobile communication system 200 according to the current exemplary embodiment may also relay packet data based on high speed packet access (HSPA). Accordingly, the requesting terminal 110 may be implemented as a terminal that can support HSPA.

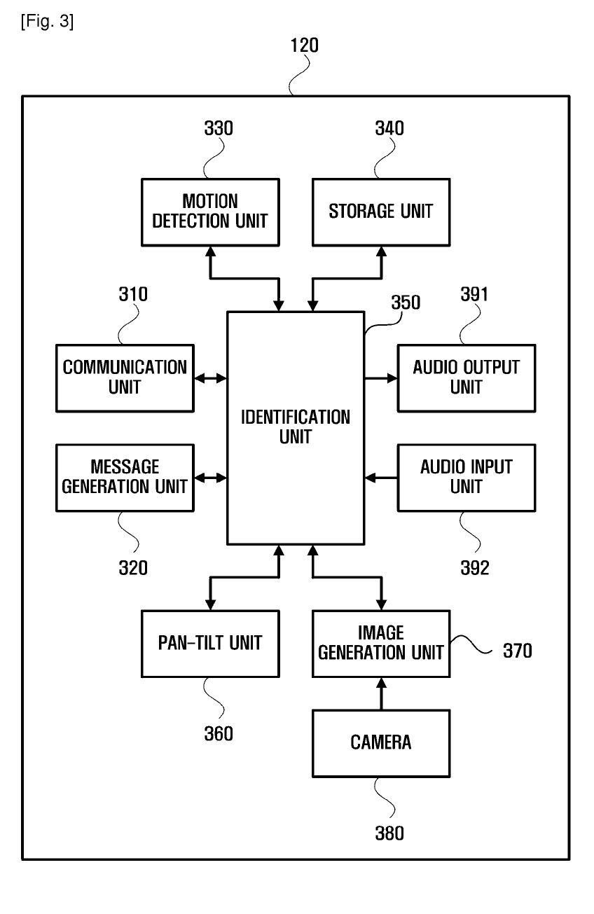

FIG. 3 is a block diagram of an apparatus 120 for transmitting multimedia contents according to an exemplary embodiment of the present invention. Referring to FIG. 3, the apparatus 120 includes a communication unit 310, a message generation unit 320, a motion detection unit 330, a storage unit 340, an identification unit 350, a pan-tilt unit 360, an image generation unit 370, a camera 380, an audio output unit 391, and an audio input unit 392.

The communication unit 310 receives a call channel request signal, a satellite terminal designation request signal, a pan-tilt control request signal, and a stored content request signal. The communication unit 310 may receive the call channel request signal and the stored content request signal via the MSC 230 and receive the satellite terminal designation request signal and the pan-tilt control request signal via the SGSN 290.

The call channel request signal is an incoming call transmitted from the requesting terminal 110 to request a call channel. When receiving the call channel request signal, the identification unit 350 drives the camera 380 by supplying power to the camera 380 and transmits an image generated as a result of driving the camera 380 to the requesting terminal 110.

The call channel request signal according to the current exemplary embodiment may also be generated by the motion detection unit 330. That is, the motion detection unit 330 may detect motion in its surroundings and generate the call channel request signal based on the detection result.

To this end, the motion detection unit 330 may include an infrared sensor, a vision sensor, an ultrasonic sensor, a microwave sensor, or the like. The infrared sensor senses the distance from an object and the motion of the object by using the change in infrared radiation in its surroundings. The vision sensor senses the motion of an object by using an input image. The ultrasonic sensor, like a sound navigation and ranging (SONA) sensor, senses the distance from an object and the motion of the object by using an ultrasonic wave reflected off the object.

The motion detection unit 330 may include at least one of the infrared sensor, the vision sensor, the ultrasonic sensor, and the microwave sensor. Thus, the motion detection unit 330 may detect the motion of an object using a single sensor or a combination of sensors.

The satellite terminal designation request signal is received when the apparatus 120 for transmitting multimedia contents functions as the representative apparatus 410 shown in FIG. 4. When receiving the satellite terminal designation request signal, the communication unit 310 transmits a satellite terminal designation message to a corresponding satellite terminal, receives an image from the satellite terminal in return, and transmits the received image to the requesting terminal 110.

The pan-tilt control request signal is received when the apparatus 120 includes a pantilt apparatus. The pan-tilt unit 360 performs a pan-tilt operation in response to the pantilt control request signal.

The stored content request signal is received from the requesting terminal 110 which desires to receive multimedia contents stored in the storage unit 340. When receiving the stored content request signal, the identification unit 350 extracts multimedia contents from the storage unit 340 and transmits the extracted multimedia contents to the requesting terminal 110 via the communication unit 310.

The storage unit 340 stores a plurality of multimedia contents. Thus, the requesting terminal 110 may insert information, which designates specified multimedia contents, into the stored content request signal and transmit the stored content request signal. Accordingly, the identification unit 350 extracts the multimedia contents from the storage unit 340 and transmits the extracted multimedia contents to the requesting terminal 110.

As described above, the communication unit 310 receives signals from the MSC 230 and the SGSN 290 and transmits messages to the satellite terminals 421 through 424. Accordingly, the communication unit 310 may include a plurality of communication media, each transmitting or receiving a different type of signal or message and using a different communication method.

The apparatus 120 for transmitting multimedia contents according to the current exemplary embodiment may also transmit an image to a plurality of requesting terminals. To this end, the communication unit 310 may include a plurality of communication modules. Here, a unique phone number may be assigned to each communication module. Therefore, if the communication unit 310 includes four communication modules, four requesting terminals may form four separate communication channels with the apparatus 120 and receive an image through the separate communication channels.

To form a communication channel, a user of the requesting terminal 110 may use a phone number of any one of a plurality of communication modules included in the communication unit 310. For example, when the user of the requesting terminal 110 enters a phone number of a communication module selected from the communication modules and presses the ‘Call’ button, the requesting terminal 110 forms a communication channel with the selected communication module, and an image is transmitted to the requesting terminal 110 through the communication channel.

The user of the requesting terminal 110 may also form a communication channel by using a representative phone number of the communication unit 310. For example, the user of the requesting terminal 110 may enter the representative phone number of the communication unit 310 and press the ‘Call’ button. Then, a communication channel may be formed between one of the communication modules, which is not being used, and the requesting terminal 110.

When the user of the requesting terminal 110 uses the representative phone number, there is no need for the user to remember phone numbers of all communication modules of the communication unit 310. That is, the user of the requesting terminal 110 just has to remember the representative phone number to receive an image. Thus, the communication unit 310 may include a separate communication module to which the representative phone number is assigned.

The message generation unit 320 generates an announcement message, a satellite terminal designation message, or a pan-tilt control message.

The announcement message is a message that is transmitted to the requesting terminal 110. When an image cannot be transmitted to the requesting terminal 110 since the image is now being transmitted to another requesting terminal or the number of requesting terminals which can receive the image exceeds a predetermined number, the announcement message is used to inform this situation.

The satellite terminal designation message is a message that is transmitted to a satellite terminal. The satellite terminal designation message is generated when the satellite terminal designation request signal is received. A satellite terminal, which receives the satellite terminal designation message, generates an image of a subject captured by its camera and transmits the generated image to the communication unit 310.

Then, the identification unit 350 identifies whether the received image has been transmitted from the satellite terminal. When determining that the received image has been transmitted from the satellite terminal, the identification unit 350 transmits the received image to the requesting terminal 110 through the communication unit 310. Accordingly, the user of the requesting terminal 110 can be provided not only with an image captured by the camera 380 of the apparatus 120 but also with an image generated by a satellite terminal which is connected to the apparatus 120.

As described above, the pan-tilt unit 360 performs the pan-tilt operation in response to a received signal. When the pan-tilt unit 360 is implemented as a separate external apparatus (hereinafter, referred to as a “pan-tilt control apparatus”) as illustrated in FIG. 3, the message generation unit 320 may generate a pan-tilt control message and transmit the generated pan-tilt control message to the pan-tilt control apparatus. The pan-tilt control message may be generated when the pan-tilt control request signal is received. In addition, the pan-tilt control message may be generated to control the pantilt control apparatus included in a satellite terminal.

The identification unit 350 identifies the type of a signal that is received. That is, the communication unit 310 receives the call channel request signal, the satellite terminal designation request signal, the pan-tilt control request signal, and the stored content request signal. Thus, the identification unit 350 identifies whether a received signal is the call channel request signal, the satellite terminal designation request signal, the pan-tilt control request signal, or the stored content request signal.

The identification unit 350 may determine whether to drive the camera 380 based on the type of a signal that is received. For example, when a received signal is the call channel request signal, the identification unit 350 may supply power to the camera 380.

In addition, the identification unit 350 may control the communication unit 310, the message generation unit 320, the motion detection unit 330, the storage unit 340, the pan-tilt unit 360, the image generation unit 370, the camera 380, the audio output unit 391, and the audio input unit 392. That is, the identification unit 350 may control the operation of each module and relay data between the modules.

The image generation unit 370 generates an image of a subject captured by the camera 380. Here, the image generated by the image generation unit 370 may be a still image or a moving image.

The audio output unit 391 outputs an audio signal. That is, the audio output unit 391 converts an electrical signal having audio information into vibrations of a diaphragm to create longitudinal waves in the air and radiates sound waves. Generally, a speaker may be used as the audio output unit 391.

The audio output unit 391 may convert an electrical signal into sound waves by using an dynamic, electromagnetic, electrostatic, dielectric or magnetostrictive method.

Since the audio output unit 391 is included in the apparatus 120 for transmitting multimedia contents, an audio signal transmitted from the user of the requesting terminal 110 can be output from the audio output unit 391.

The audio input unit 392 receives an audio signal. That is, the audio input unit 392 converts sound energy into electric energy. Generally, a microphone is used as the audio input unit 392.

The audio input unit 392 may convert an audio signal into electric energy using one of an electric resistance change method, a piezoelectric method, a magnetic change method, a dynamic method, and an electrostatic capacitance method. The electric resistance change method causes electric resistance to change using sound pressure, and the piezoelectric method changes a voltage using sound pressure to induce the piezoelectric effect. In the magnetic change method, the vibrations of thin metal foil generate a voltage, which, in turn, changes magnetism. In the dynamic method, a movable coil is placed around a cylindrical magnet. Then, the coil is moved using a diaphragm, and electric current generated by the coil is used. In the electrostatic capacitance method, a condenser is formed by placing a diaphragm, which is made of metal foil, to face a fixed electrode, and the capacitance of the condenser is changed as the diaphragm is moved by sound.

Since the audio input unit 392 is included in the apparatus 120 for transmitting multimedia contents, the requesting terminal 110 can receive sounds input to the audio input unit 392. That is, when the communication unit 310 transmits an image generated by the image generation unit 370, it can also transmit sounds around a subject which are input to the audio input unit 392.

The storage unit 340 stores images generated by the image generation unit 370 and sounds input to the audio input unit 392, that is, stores multimedia contents. An administrator may set a time when, intervals at which, and a period in which multimedia contents are automatically stored in the storage unit 340. Thus, the apparatus 120 for transmitting multimedia contents may include a timer (not shown).

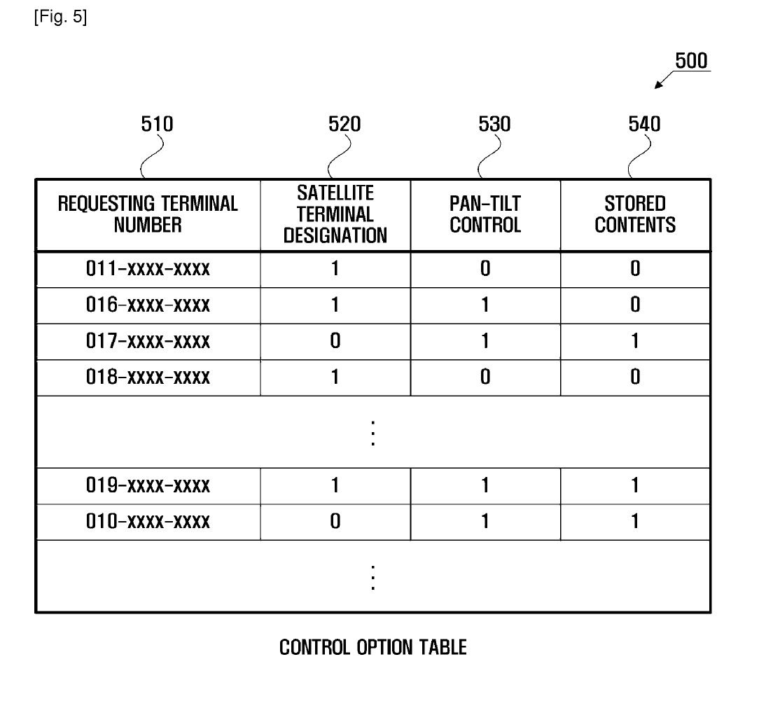

The storage unit 340 may also temporarily store an image received from a satellite terminal or store a control option table 500 (see FIG. 5) which will be described later.

The storage unit 340 may be implemented as a module to/from which information can be input or output. Examples of the storage unit 340 may include a compact flash (CF) card, a secure digital (SD) card, a smart media (SM) card, a multimedia card (MMC), and a memory stick. The storage unit 340 may be included in the apparatus 120 for transmitting multimedia contents or in a separate apparatus. When the storage unit 340 is included in the separate apparatus, the communication unit 310 may exchange data with the separate apparatus.

FIG. 4 is a diagram illustrating a terminal relay system according to an exemplary embodiment of the present invention. Referring to FIG. 4, the representative apparatus 410 for transmitting multimedia contents is connected to the satellite terminals 421 through 424 by a relay apparatus 400.

Since the representative apparatus 410 is connected to the satellite terminals 421 through 424, the requesting terminal 110 can receive images from the satellite terminals 421 through 424 through a communication channel connected to the representative apparatus 410.

For example, the requesting terminal 110 may transmit a signal designating the first satellite terminal 421 to the representative apparatus 410 so as to receive an image from the first satellite terminal 421. Accordingly, the representative apparatus 410 may transmit a satellite terminal designation message to the first satellite terminal 421, receive an image from the first satellite terminal 421, and transmit the received image to the requesting terminal 110.

Here, the first satellite terminal 421, which receives the satellite terminal designation message, may transmit, in real time, an image of a subject captured by its camera and sounds input to the audio input unit 392 or may transmit pre-stored multimedia contents. To this end, the satellite terminal designation message may include a flag for requesting a real-time image and sound or a flag for requesting pre-stored multimedia contents.

The representative apparatus 410 may transmit an image received from at least one of the satellite terminals 421 through 424 and an image that it generated to the requesting terminal 110.

The relay apparatus 400 illustrated in FIG. 4 relays data between the representative apparatus 410 and the satellite terminals 421 through 424. The relay apparatus 400 may be implemented as a separate apparatus as illustrated in FIG. 4 or may be included in the representative apparatus 410.

A communication method used between the representative apparatus 410, the relay apparatus 400, and the satellite terminals 421 through 424 may be a wired communication method, such as Ethernet, a universal serial bus (USB), Institute of Electrical and Electronics Engineers (IEEE) 1394, serial communication, or parallel communication, or a wireless communication method such as infrared communication, Bluetooth, a home radio frequency (RF), a wireless local area network (WLAN), or a mobile communication network.

FIG. 5 is a diagram illustrating the control option table 500 according to an exemplary embodiment of the present invention. Referring to FIG. 5, the control option table 500 includes a requesting terminal number field 510, a satellite terminal designation field 520, a pan-tilt control field 530, and a stored content field 540.

The control option table 500 according to the current exemplary embodiment specifies a control option of each requesting terminal. For example, each of the satellite terminal designation field 520, the pan-tilt control field 530, and the stored content field 540 shows a flag of zero or one for each requesting terminal. Here, “zero” indicates that a corresponding option is not given to a requesting terminal, and “one” indicates that the option is given to the requesting terminal.

Using the control option table 500, an administrator may give an option to designate a satellite terminal to specified requesting terminals, give a pan-tilt control option to specified requesting terminals, and give an option to provide stored contents to specified requesting terminals.

Accordingly, when receiving one of the satellite terminal designation request signal, the pan-tilt control request signal, and the stored content request signal from a requesting terminal, the identification unit 350 of the apparatus 120 for transmitting multimedia contents may determine whether the requesting terminal has an option for the received signal with reference to the control option table 500 and determine whether to designate a satellite terminal, perform the pan-tilt control, or provide the stored contents based on the determination result.

The control option table 500 according to the current exemplary embodiment may be stored in the MSC 230 or the SGSN 290 of the mobile communication system 200 and used to determine whether to designate a satellite terminal, perform the pan-tilt control, or provide the stored contents.

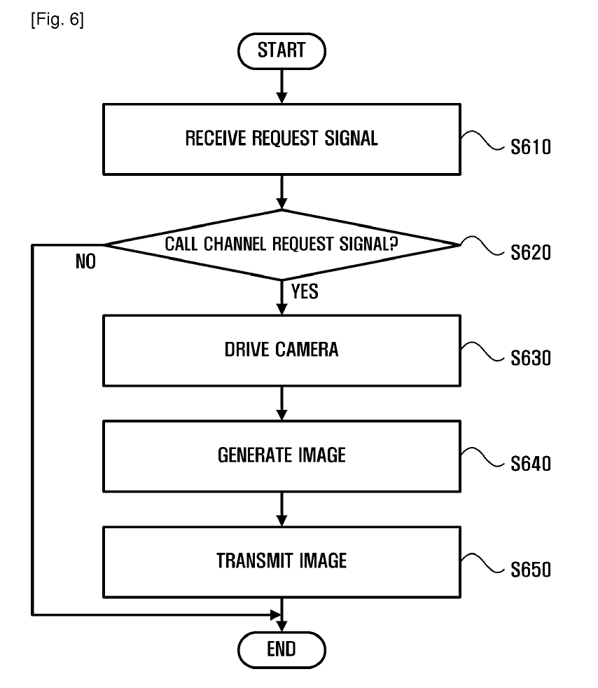

FIG. 6 is a flowchart illustrating a method of transmitting multimedia contents according to an exemplary embodiment of the present invention.

Referring to FIG. 6, to transmit multimedia contents, the communication unit 310 of the apparatus 120 for transmitting multimedia contents receives a request signal (operation S610). Here, the request signal may be a call channel request signal, a satellite terminal designation request signal, a pan-tilt control request signal, or a stored content request signal. The identification unit 350 identifies whether the received request signal is the call channel request signal (operation S620).

When determining that the received request signal is the call channel request signal, the identification unit 350 supplies power to the camera 380, thereby driving the camera 380 (operation S630).

Accordingly, the image generation unit 370 generates an image of a subject captured by the camera 380 (operation 5640) and transmits the generated image to the requesting terminal 110 via the communication unit 310 (operation S650).

As described above, the received signal may be a request signal received through the communication unit 310 or the call channel request signal generated by the motion detection unit 330. When the audio input unit 392 is included in the apparatus 120 for transmitting multimedia contents, the communication unit 310 may transmit sounds together with an image.

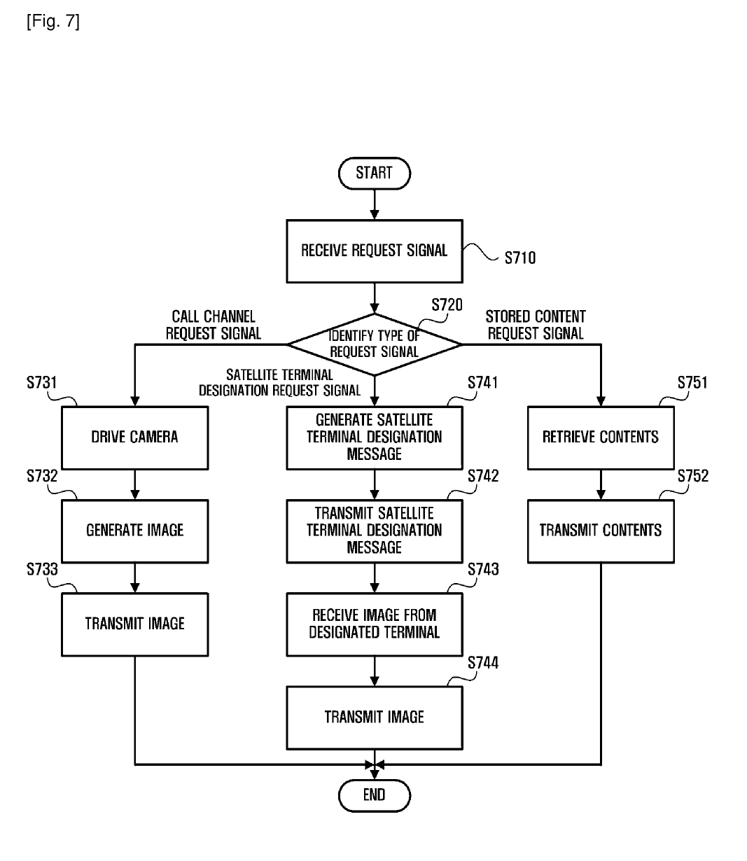

FIG. 7 is a flowchart illustrating a method of transmitting multimedia contents according to another exemplary embodiment of the present invention. In the method illustrated in FIG. 7, a processing path varies according to the type of a request signal that is received.

Referring to FIG. 7, the communication unit 310 receives a request signal and transmits the received request signal to the identification unit 350 (operation S710). Then, the identification unit 350 identifies the type of the received request signal (operation S720). As described above, the request signal may be a signal received by the communication unit 310 or a signal generated by the motion detection unit 330.

When it is identified that the received request signal is a call channel request signal, the identification unit 350 drives the camera 380 (operation 5731) as in the method of FIG. 6. Then, the image generation unit 370 generates an image (operation S732), and the communication unit 310 transmits the generated image (operation S733).

When it is identified that the received request signal is a satellite terminal designation request signal, the message generation unit 320 generates a satellite terminal designation message (operation S741). Then, the communication unit 310 transmits the generated satellite terminal designation message to a corresponding satellite terminal (operation 5742) and receives an image from the satellite terminal in return (operation S743).

Here, the satellite terminal designation message may include a flag for requesting a real-time image or a flag for requesting stored multimedia contents. Thus, the satellite terminal may transmit an image or multimedia contents based on a flag included in the satellite terminal designation message.

The identification unit 350 temporarily stores the received image or multimedia contents in the storage unit 340 and transmits the stored image or multimedia contents to the requesting terminal 110 using the communication unit 310 (operation S744). Here, the received image is temporarily stored in the storage unit 340 in order for buffering. When no buffering is performed, the received image may be immediately transmitted to the requesting terminal 110 via the communication unit 310.

When it is identified that the received request signal is a stored content request signal, the identification unit 350 searches the storage unit 340 for corresponding multimedia contents (operation 5751) and transmits the found multimedia contents to the requesting terminal 110 using the communication unit 310 (operation S752).

As described above, the apparatus 120 for transmitting multimedia contents according to the current exemplary embodiment may transmit multimedia contents to a plurality of requesting terminals. Therefore, the apparatus 120 may provide multimedia contents corresponding to a request signal received from each requesting terminal.

For example, the apparatus 120 may provide an image to a first requesting terminal in response to a call channel request signal received from the first requesting terminal, provide an image received from a satellite terminal to a second requesting terminal, and provide stored multimedia contents to a third requesting terminal. Here, the apparatus 120 may simultaneously transmit multimedia contents to a plurality of requesting terminals.

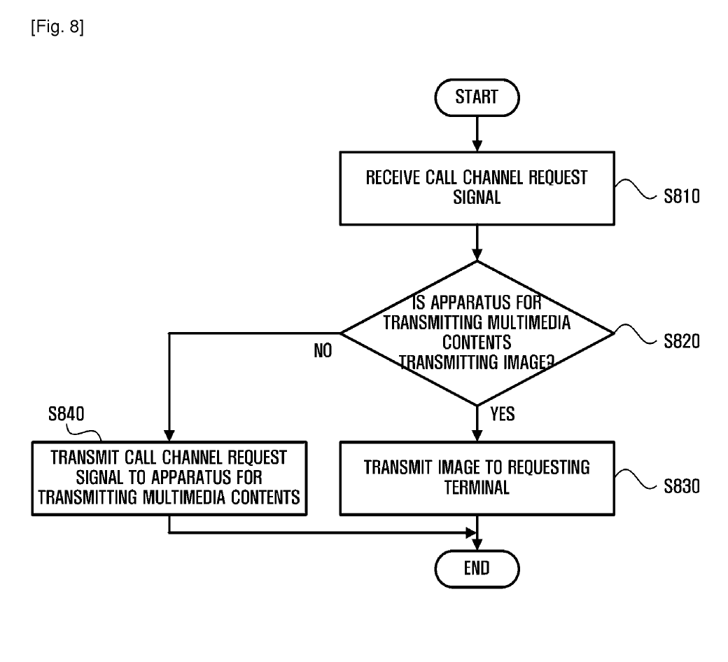

FIG. 8 is a flowchart illustrating a method of relaying multimedia contents according to an exemplary embodiment of the present invention.

Referring to FIG. 8, when the requesting terminal 110 transmits a call channel request signal, the mobile communication system 200 receives the call channel request signal (operation S810). Then, the identification apparatus identifies whether the apparatus 120 for transmitting multimedia contents, which is the destination of the call channel request signal, is currently transmitting an image (operation S820).

That is, the identification apparatus identifies whether the apparatus 120 is currently transmitting an image to another requesting terminal which made a call channel request before the requesting terminal 110.

When the identification apparatus determines that the apparatus 120 is transmitting an image to another requesting terminal, the communication apparatus transmits the image to the requesting terminal 110 (operation S830). That is, the communication apparatus transmits the image received from the apparatus 120 to both of the requesting terminal 110 and the requesting terminal which made the call channel request before the requesting terminal 110.

When the identification apparatus determines that the apparatus 120 is not transmitting the image, the communication apparatus transmits the call channel request signal to the apparatus 120 (operation S840). Accordingly, the apparatus 120 receives the call channel request signal and transmits the image to the requesting terminal 110.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

### INDUSTRIAL APPLICABILITY

An apparatus and method for transmitting multimedia contents and a system and method for relaying multimedia contents according to the present invention provide at least one of the following advantages.

First, when a call channel request signal is received from a requesting terminal, an image is generated using a camera, and the generated image is transmitted to the requesting terminal. Therefore, a user of the requesting terminal can easily identify the situation in a remote area.

Second, since images are transmitted or received using a conventional mobile communication system, the cost of implementing the entire system can be reduced.

1. An apparatus for transmitting multimedia contents, the apparatus comprising:
an identification unit identifying whether a received signal is a signal for requesting a call channel; and
a communication unit transmitting an image of a subject captured by a camera over a mobile communication network, based on the identification result.

2. The apparatus of claim 1, wherein the camera comprises at least one of a built-in camera and a camera included in an external device.

3. The apparatus of claim 2, wherein the identification unit determines whether to drive the camera based on the identification result.

4. The apparatus of claim 2, wherein the communication unit transmits an image of a subject captured by at least one of the built-in camera and the camera included in the external device.

5. The apparatus of claim 1, wherein the communication unit transmits the image to one or more terminals through one or more call channels.

6. The apparatus of claim 1, wherein the signal for requesting the call channel is an incoming call transmitted from a terminal to request a call channel so as to receive the image or an event signal generated when ambient motion is detected.

7. The apparatus of claim 6, further comprising a motion detection unit detecting the ambient motion.

8. The apparatus of claim 1, wherein the communication unit transmits sounds around the subject, together with the image.

9. The apparatus of claim 1, wherein the image of the subject captured by the camera comprises a pre-stored image.

10. A system for relaying multimedia contents, the system comprising:
an identification apparatus receiving a signal for requesting a call channel and identifying whether a first terminal requested to provide the call channel is transmitting an image; and
a communication apparatus transmitting the image to a second terminal, which requested the call channel, based on the identification result.

11. The system of claim 10, wherein the signal for requesting the call channel comprises an outgoing call transmitted from the second terminal.

12. The system of claim 10, wherein the communication apparatus transmits sounds around a subject of the image, together with the image.

13. A method of transmitting multimedia contents, the method comprising:
identifying whether a received signal is a signal for requesting a call channel; and
transmitting an image of a subject captured by a camera over a mobile communication network, based on the identification result.

14. The method of claim 13, wherein the camera comprises at least one of a built-in camera and a camera included in an external device.

15. The method of claim 14, further comprising determining whether to drive the camera based on the identification result.

16. The method of claim 14, wherein the transmitting of the image comprises transmitting an image of a subject captured by at least one of the built-in camera and the camera included in the external device.

17. The method of claim 13, wherein the transmitting of the image comprises transmitting the image to one or more terminals through one or more call channels.

18. The method of claim 13, wherein the signal for requesting the call channel is an incoming call transmitted from a terminal to request a call channel so as to receive the image or an event signal generated when ambient motion is detected.

19. The method of claim 18, further comprising detecting the ambient motion.

20. The method of claim 13, further comprising transmitting sounds around the subject, together with the image.

21. The method of claim 13, wherein the image of the subject captured by the camera comprises a pre-stored image.

22. A method of relaying multimedia contents, the method comprising:
receiving a signal for requesting a call channel and identifying whether a first terminal requested to provide the call channel is transmitting an image; and
transmitting the image to a second terminal, which requested the call channel, based on the identification result.

23. The method of claim 22, wherein the signal for requesting the call channel comprises an outgoing call transmitted from the second terminal.

24. The method of claim 22, wherein the transmitting of the image comprises transmitting sounds around a subject of the image, together with the image.
